(19) United States
(12) Patent Application Publication
(10) Pub. No.: US 2012/0158923 A1
(43) Pub. Date: Jun. 21, 2012

(54) SYSTEM AND METHOD FOR ALLOCATING RESOURCES OF A SERVER TO A VIRTUAL MACHINE

(76) Inventors: Ansari Mohamed, Santa Clara, CA (US); Kumaran Santhana-Krishman, Sunnyvale, CA (US)

(21) Appl. No.: 13/319,770

(22) PCT Filed: May 29, 2009
(86) PCT No.: PCT/US2009/045734

§ 371 Date: Nov. 10, 2011

(51) Int. Cl. G06F 15/177

(52) U.S. Cl. 709/220

(57) ABSTRACT

A system and methods of allocating resources of a server to a virtual machine are disclosed. A method comprises discovering a system configuration of the server 104 using an automated probing module 102. A networking policy and/or a storage policy may be selected by a user for the virtual machine 106 to operate on the server 104. The virtual machine 106 can then be automatically configured to operate on the server 104 using an automated configuration module 150 based on the selected networking policy and storage policy and the system configuration.

### BACKGROUND

Virtualization is one of the primary tools that an organization uses to efficiently maximize the usage of physical system resources. With virtualization, a fraction of a computer processing unit (CPU), and a slice of networking and storage bandwidth can be assigned to each virtual machine that is running on one or more physical machines. It is possible to have a setup where nearly every resource of the physical system is divided up for use by selected virtual machines.

Provisioning a server system with one or more virtual machines can be a complex and error prone process. To create multiple virtual machines on a physical server, a user typically determines the best way to share the resources available to the different virtual machines that will be created. Each virtual machine is assigned specific system resources, such as networking cards, data storage, digital memory, and computer processors. The amount of resources that are assigned, and the way in which the resources are assigned can vary broadly depending upon the needs of the virtual machine, the availability of the resources, and the desires of the user.

An even more complex problem is how fabric-shared resources such as storage arrays and computer disks are utilized by the virtual machines. Dividing the resources of fabric shared resources can be complex since a user is concerned about both sharing resources with virtual machines on the same system as well as sharing these resources across multiple physical systems on the same storage fabric.

In addition to resource allocation, a user can determine the configurations for each of the different virtualization technologies. Each technology can have its own minimum recommended configuration and limitations. The large number of variables that occur in provisioning a server system with multiple virtual machines can make the process difficult, lengthy, and inefficient.

### BRIEF DESCRIPTION OF THE DRAWINGS

FIG. 1 is an illustration of a block diagram of a system for allocating resources of a server to a virtual machine in accordance with an embodiment;

FIG. 2 provides an example configuration map in accordance with an illustrated embodiment;

FIG. 3 provides an example of high level policies regarding networking for provisioning a virtual machine onto a server system in accordance with a selected embodiment;

FIG. 4 provides an example of high level policies regarding storage for provisioning a virtual machine onto a server system in accordance with a selected embodiment; and

FIG. 5 is a flow chart depicting a method for allocating resources of a server to a virtual machine in accordance with an embodiment.

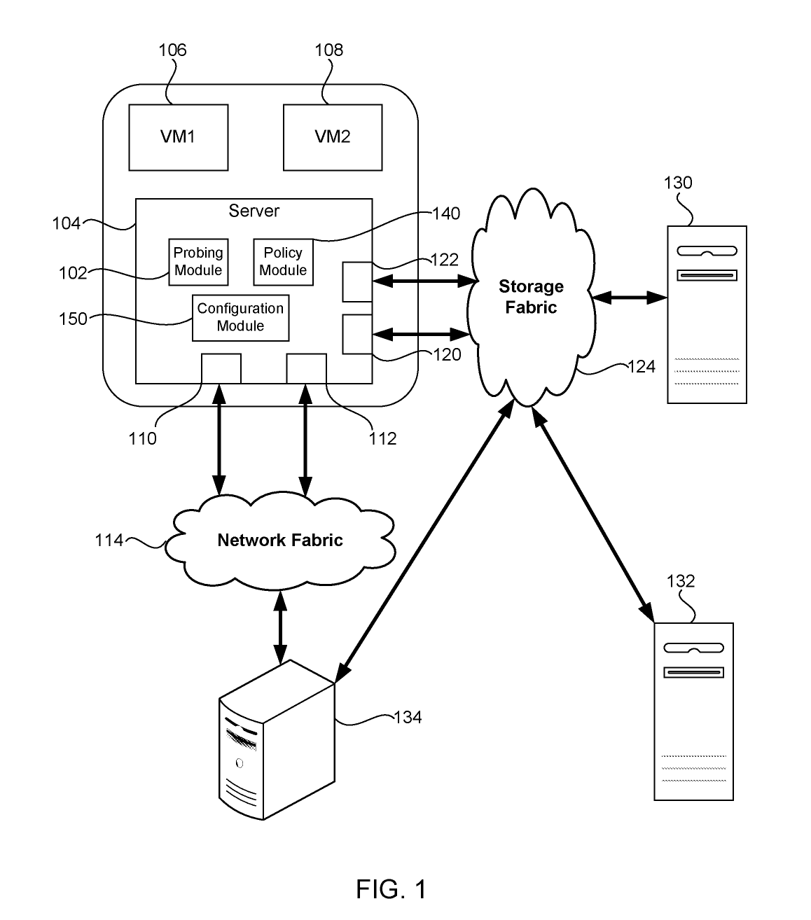

### DETAILED DESCRIPTION

The complexity of allocating resources of a server system to at least one virtual machine can be substantially reduced by defining high level policies that can be used to constrain the configuration of the virtual machines on the server system. In a computer testing lab, various resources can be allocated to test as many unique combinations of resource sharing as can be supported by the virtualization software and the hardware on which it is run. Policies can be set by a user that defines the unique combinations of resource sharing.

In a production environment, high level policies can be defined for virtual machines. These policies can then be applied to a physical server pool to come up with the best possible virtual environment that meets those policies.

In both a test and production environment, the creation of a set of policies can reduce or eliminate the need for a user to manually discover a physical server configuration and determine an optimal configuration for allocating resources of the server system to the virtual machine(s). The allocation of the resources of the server system to a virtual machine is typically referred to as provisioning. The ability to automatically provision the server system can save substantial amounts of time and significantly reduce errors created by manually provisioning the server system for one or more virtual machine(s).

A first step in virtual machine provisioning on a server system is to determine the configuration of the server system. The configuration discovery of the system is typically a manual process. The configuration discovery comprises determining the server system's physical resources and the fabric that connects it to external resources. The user can use various system tools and applications to obtain a picture of how the network and storage resources are connected and what their capabilities are.

Due to the shared nature of a networked system and the system's shared storage fabric, it is valuable to determine how a shared resource such as a fiber channel array will be divided between multiple physical systems in the same fabric. Without this information, a user can potentially come up with a configuration where the same disks are shared between two different servers or between multiple virtual machines residing on those servers. Sharing the same disks can lead to data corruption and other serious side effects that may impact the stability of the networked system and virtual machines.

In accordance with one embodiment of the present disclosure, an automated probing module 102 can be used to discover a system configuration of the server system 104. The server system may comprise a single server or a plurality of servers interconnected through a network or the internet. The probing module can be used to determine the physical components of the server system that may be used by one or more virtual machines 106, 108.

For example, in one embodiment the probing module 102 can be used to determine the type of networking cards 110, 112 that are used for external communications. Information regarding the networking cards can include details such as the networking cards physical layer, network layer, transport layer, and other types of pertinent OSI layer information. The type of driver used by each networking card can also be useful. Details can also be collected regarding the network fabric 114, comprising the switching scheme through which the network cards 110, 112 of the server system 104 communicate with external sources such as other servers.

Information can also be gathered regarding the digital storage resources available to the virtual machines 106, 108 that will be setup to operate on the server system 104. Information can include the type of host bus adapter 120, 122 that is used to connect the server system with the storage resources 130, 132, 134. The probing module 102 can be used to determine the storage resources properties and driver information. For each host bus adapter, it can be determined the type of connectivity between the adapter 120, 122 and the storage fabric 124. The connectivity between the storage fabric and the physical storage devices 130, 132, 134 can also be determined. The driver information of the host bus adapter, the switches in the storage fabric 124, and the storage devices 130, 132, 134 can be identified. The properties of each hard disk in the storage devices can also be identified. For example, it can be determined whether the storage device is a rotatable storage device, such as an optical or magnetic storage medium, or alternatively, a solid state storage device. Other information can include the type of disk, its properties, its world wide identifier, the type of content it stores, and so forth. The disks properties can include whether it is part of an array such as a storage area network (SAN) array, the type of array, whether the disk can be partitioned into logical volumes or used as a whole disk, etc.

The storage devices 130, 132, 134 can be interconnected with the server system 104 through storage fabric 124. Each host bus adapter 120, 122 can communicate with the storage fabric using a fibre channel, SCSI, SAS, or other type of technology, as can be appreciated.

In addition to networking and storage information, other types of information can be obtained by the probing module 102, such as CPU information and physical memory information of the server system 104. CPU information can include the type of CPU, the speed of the CPU, the number of cores in the CPU, etc. Memory information includes the type of memory, the amount of physical memory, the speed of the memory, and so forth.

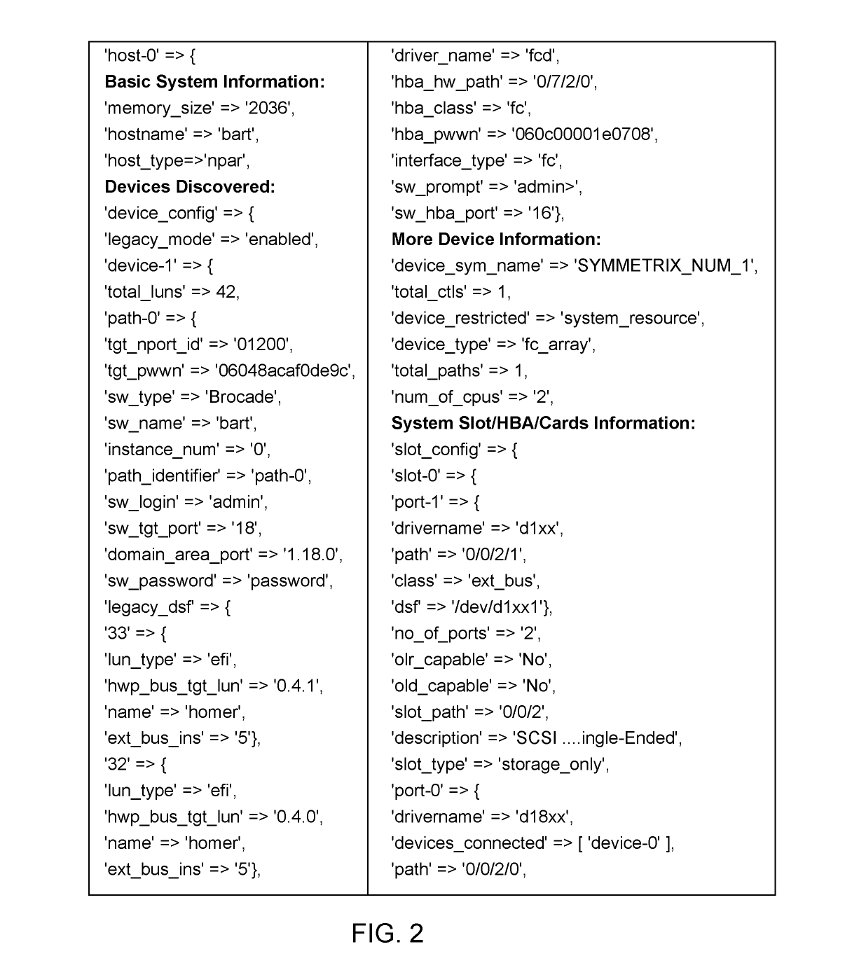

In accordance with one exemplary embodiment of the disclosure, configuration information, such as the information shown in the example configuration map 200 in FIG. 2, can be gathered by the automated probing module 102 for the server system 104.

The configuration information shown in FIG. 2 is not considered to be a complete list. Rather, it is given as an example of the type of configuration information that can be gathered using the automated probing module 102. Additional information may be gathered based on the type of server system, the type of virtual machine being provisioned onto the server system, and the needs of the user, as can be appreciated. The configuration information can be used to form a configuration map. A relationship of shared resources between the network servers can be determined using the configuration map.

In a test environment, the purpose of testing a virtual machine can be to validate the virtual machine product itself. The scope can be to cover the entire support matrix of the product. For example, with a Hewlett Packard Unix server (HP-UX), the parameters of the server system hardware that can be tested include whether specific host bus adapters and networking cards can be shared with virtual machines. Additional testing can be performed to determine whether a networking card can be exposed to a virtual machine through “standard” and/or “performance” type interfaces. A networking card can also be shared as a physical card. Alternatively, an aggregate of networking cards can be created using aggregate protocols such as Link Aggregation Control Protocol (LACP) or Port Aggregation Protocol (PAgP).

The terms “standard” and “performance”, as used in the present application, are intended to refer to two different types of systems. In a standard system, a virtual software layer is incorporated between a virtual machine and the actual hardware, such as the networking interface. In a performance system, the virtual layer is omitted and the system is referred to as a paravirtualization system. Instead of using a virtual layer to connect the virtual machine to the networking card, the virtual machine can directly interface with the hardware, without the need for an additional layer of software. The physical interface with the hardware in a paravirtualization may reduce the flexibility of how the hardware can be used by multiple virtual machines. However, the removal of the additional layer of virtualization software can substantially increase the speed at which the hardware can be used. Thus, in some situations, a standard network interface may be preferred, since the virtual layer of software between the network interface and the virtual machine may enable additional flexibility, such as the ability of the virtual machine to share the network interface with multiple other virtual machines. In other situations, a faster connection may be obtained through the use of a performance, type network interface, wherein the hardware interface may only allow a single virtual machine to use the selected network interface, but with a greater overall network throughput.

Testing with regards to digital storage can include a determination as to whether a specific host bus adapter can be shared with the virtual machines 106, 108. It can be determined whether a disk can be exported as a “standard” and/or performance disk to the virtual machines. Another configuration parameter that can be determined is whether a disk exposed to one or more virtual machine can be seen through a supported host bus adapter. It can be determined whether a backing store for a particular virtual machine is a logical volume (using, for example, a Logical Volume Manager (LVL) or a Veritas Volume Manager (VxVM)), a file, a partition of a disk, or a whole disk. It can also be determined whether the ports on virtual switches used to connect the physical networking cards to the virtual machines have virtual local area networks that are enabled or disabled.

Either before or after the configuration of the server system 104 has been discovered using the probing module 102, a user can select from various high level policies useful in reducing the number of decisions necessary to provision a virtual machine 106, 108 on the server system 104. The high level policies may be presented to the user using a graphical user interface. Alternatively, the user may select desired policies using another type of interface, such as a text based interface.

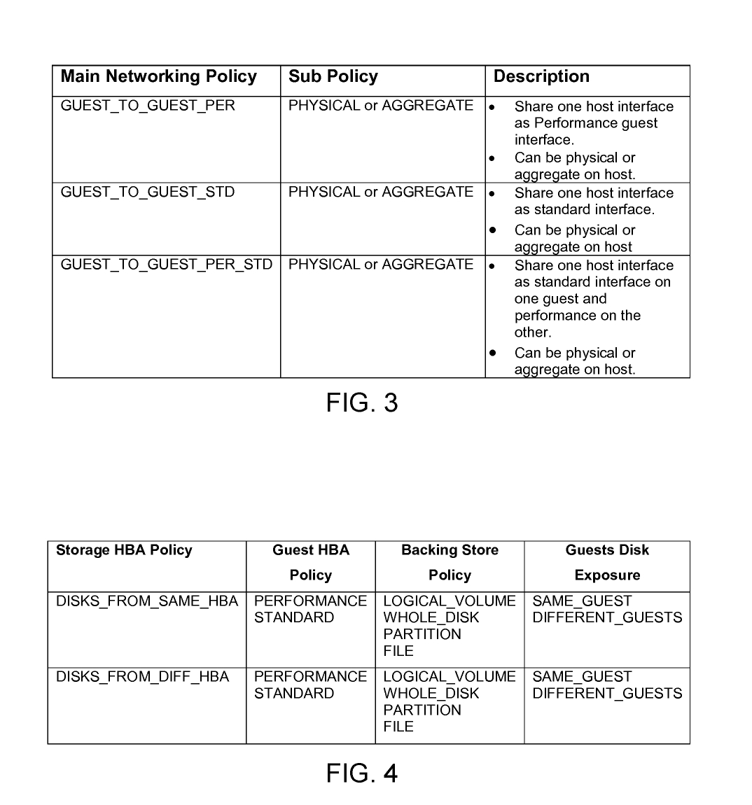

In one embodiment, the various different ways of provisioning the virtual machine onto the server system can be limited by high level policies such as those illustrated in the table provided in FIG. 3.

In the example embodiment shown in FIG. 3, the policy and sub-policy for networking resource sharing can be specified by a user as input to a policy module 140. The user can select between various main networking policies, such as whether a particular host interface 110, 112 is shared between virtual machines 106, 108 as a performance interface, a standard interface, or both for a particular guest. A sub policy for networking can enable a user to select whether the virtual machines are connected with the host interfaces as a physical connection or an aggregate connection, as previously discussed. Alternatively, the user can select a sub-policy that either a physical or aggregate configuration can be used, enabling flexibility when the policies are implemented.

Similarly, high level policies regarding storage can be implemented using the policy module 140. Exemplary storage policies are illustrated in the table shown in FIG. 4.

In the example embodiments provided in FIG. 4, a user can set specific high level storage policies. These storage policies will be followed, when possible, to provision a server system with virtual machines. For example, there can be a policy as to whether virtual machines use storage disks that are all connected to the same host bus adapter, or disks that are connected to multiple different host bus adapters. A policy can be selected by a user as to whether the host bus adapter used by a virtual machine operates on a performance level, or a standard level. As previously discussed, the standard level can be obtained by accessing data storage through a virtual software layer. The performance level can provide greater bandwidth by enabling access to data storage through hardware, without the additional virtual software layer. However, the performance level may be more limited than the standard level. For example, the standard level host bus adapter may be accessible to multiple virtual machines, while a performance level host bus adapter may be limited to a single virtual machine, or only virtual machines physically located on the same server as the performance level host bus adapter.

A policy can also be established by the user for the creation of a backing store. The user can select whether the backing store is formed on a whole disk, a logical volume of a disk, a partition of a disk, or a single file on a disk. In one embodiment, the user can select more than one type of backing store.

A policy can be established by the user as to how a guest using a virtual machine is exposed to the storage assigned to a particular virtual machine. The user can select whether each guest is assigned a specific storage area, such as a whole disk, a logical volume, or a partition of a disk. Alternatively, the user can allow different guests to share the available physical storage space.

Using the policy module 140, the user can specify the desired parameters listed above. A configuration module 150 can then provision the server system 104 with virtual machines based on the specified high level policies selected by the user. The configuration module is configured to set up the virtual machine on the server system based on the policies that were selected.

The configuration module 150 can use the system configuration, as determined by the probing module 102, and the individual policy settings for networking and storage available from the policy module 140 to provision the server system 104 with one or more virtual machines. The configuration module may not be able to meet every policy selected by a user for every configuration. This may be due to a limitation in the system configuration.

For example, in a selected sample configuration, there may be two networking cards 110, 112 in the physical system. The user may select the following network policies:

Main Networking Policy: Guest_To_Gest_Per_STD

Sub Policy: Aggregate

The configuration module 150 can check the configuration map created by the probing module 102 to see if two guests can be created on the system. Each guest can require a certain amount of memory to operate in the virtual machine. Therefore, the configuration module can check the virtual machine memory requirements and the physical memory availability. The configuration module can also check to see if at least two physical interfaces are available for networking. This is necessary since the user has selected that network communications be done through an aggregate networking connection. In some types of physical systems, such as an HP-UX server, at least two network interfaces are required to support an aggregate connection.

The configuration module 150 can determine if the physical networking ports coupled to the networking cards 110, 112 are compatible and meet the requirements for aggregation. The configuration module 150 can also determine whether aggregation software is installed on the server system 104. If all of the requirements are met, then the configuration module can create the aggregate connection and setup the virtual machine for two guests.

In one embodiment, the aggregate connection created by the configuration module 150 may be used as either a performance connection, wherein at least one network interface card is connected to the virtual machine directly to form a paravirtual connection, and at least one card includes an additional virtual layer to form a standard connection. Using the new aggregate that was created, the configuration module can expose it to one guest as a performance interface and to the other as a standard interface.

The same exemplary configuration may include two storage host bus adapters 120, 122. The user may select the following policies with regards to storage:

Storage HBA policy: Disks_From_Diff HBA

Guest HBA Policy: Performance

Backing Store Policy: Logical_Volume and Whole_Disk and File

Guest Disk Exposure: Different_Guests

The configuration module 150 can look to see if two guests can be created on the system. This can be done by checking the virtual machine memory requirements and the physical memory availability. Since the user policy requires disks from different host bus adapters, the configuration module looks to see if at least two host bus adapters are present. If not, this will be an exception that can be handled by the user.

The user has asked for a logical volume, a whole disk, and also a file backing store. The configuration module 150 can be used to verify whether there are enough physical resources to meet all three requirements for the backing store policy. For example, if there are only two disks available, one of the disks can be used as a whole disk and the other can be used to create two logical volumes. One of the logical volumes can be used as the backing store directly. The other logical volume can be used to create a file to use as a file backing store.

Since the user has asked for these combinations to be supported on multiple guests, the configuration module 150 can verify that there are enough physical resources to meet all these requirements for at least two guests. The configuration module can create the logical volumes and the files necessary for the backing store. The configuration module can also setup the server system to host the two guests on the virtual machine. Additionally, the configuration module can expose the appropriate physical resources to the guests based on the above policy processing.

In one embodiment, the configuration module can create a “proposed” configuration map. This map may be similar to the configuration map formed by the probing module 102. This can be used to give the user a visual mapping of how the proposed virtual machine configuration will look like. The user may alter the configuration by updating the proposed configuration map. Once the user is satisfied with the proposed configuration map, the user can instruct the configuration module 150 to create the configuration. The creation of the configuration by the configuration module will result in the formation of the one or more virtual machines desired by the user. Once the virtual machines have been created, the machines may be further adjusted by the user or tested in a testing lab.

In instances where the configuration module determines that a particular high level policy for a virtual machine that was selected by the user cannot be met due to hardware limitations, the configuration module can be configured to instruct the user why the configuration cannot be accomplished. The configuration module can then give the user additional options. For example, the configuration module may instruct the user that an aggregate connection cannot be accomplished since the aggregation software is not present. The user can then install the aggregation software and attempt to configure the virtual machine again using the configuration module 150. Alternatively, different choices may need to be made by the user. If the network interface cards present in the server system are not compatible with aggregation, the user may have to change the high level policy to use a physical connection.

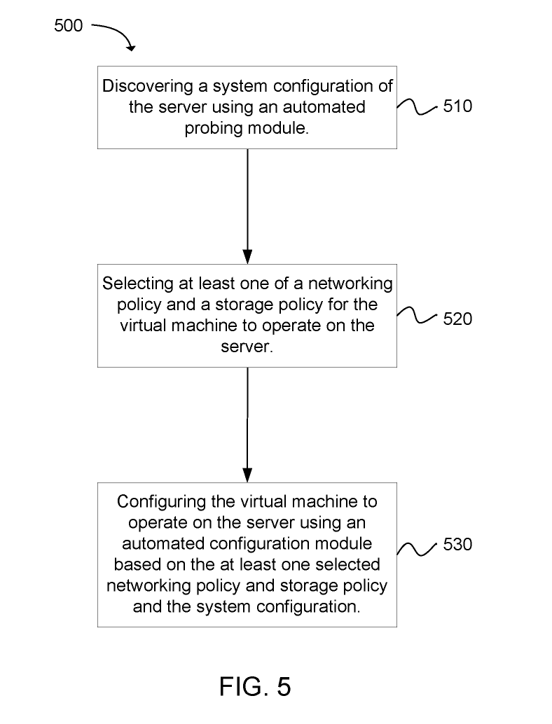

In another embodiment, a method 500 of allocating resources of a server to a virtual machine is disclosed, as illustrated in the flow chart of FIG. 5. The method comprises the operation of discovering 510 a system configuration of the server using an automated probing module. The method further includes the operation of selecting 520 at least one of a networking policy and a storage policy for the virtual machine to operate on the server. An additional operation comprises configuring 530 the virtual machine to operate on the server using an automated configuration module based on the at least one selected networking policy and storage policy and the system configuration.

The probing module, 102, policy module 140, and configuration module 150 can be used to efficiently provision a server based upon high level policies selected by a user. In a testing environment, the modules can be used to quickly setup a large number of virtual machines based on different policy selections. This allows the virtual machines to be more easily created, thereby enabling testing to be carried out without the need for a cumbersome setup process prior to testing. In a production environment, the modules are useful to allow a manager to quickly provision a server with virtual machines based on the manager's needs, thereby saving the manager the extensive amounts of time typically needed to provision a server with virtual machines.

It should be understood that many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Reference throughout this specification to “one embodiment” or “an embodiment” means that a particular feature, structure, or characteristic described in connection with the embodiment is included in at least one embodiment of the present disclosure. Thus, appearances of the phrases “in one embodiment” or “in an embodiment” in various places throughout this specification are not necessarily all referring to the same embodiment.

The described features, structures or characteristics described herein may be combined in any suitable manner in one or more embodiments. Furthermore, one skilled in the relevant art will recognize that the invention can be practiced without one or more of the specific details, methods, components, materials, etc. In other instances, well-known components, methods, structures, and materials may not be shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A method of allocating resources of a server 104 to a virtual machine 106, comprising:
discovering a system configuration of the server 104 using an automated probing module 102;
selecting at least one of a networking policy and a storage policy for the virtual machine 106 to operate on the server 104; and
configuring the virtual machine 106 to operate on the server using an automated configuration module 150 based on the at least one selected networking policy and storage policy and the system configuration.

2. The method of claim 1, further comprising provisioning a plurality of virtual machines to operate on a plurality of servers.

3. The method of claim 2, further comprising creating a configuration map of system resources of the plurality of servers.

4. The method of claim 3, further comprising determining a relationship of shared resources between the network servers using the configuration map.

5. The method of claim 1, wherein setting a networking policy further comprises setting a networking host interface on the server as at least one of a performance guest interface and a standard guest interface.

6. The method of claim 1, further comprising setting a networking sub-policy wherein a user can select between using at least one of a single networking connection or an aggregate networking connection with the server.

7. The method of claim 1, wherein setting a storage policy further comprises selecting between using digital storage from a same or different host bus adapter.

8. The method of claim 1, wherein setting a storage policy further comprises selecting between using at least one of a standard storage device and a performance storage device on a host bus adapter.

9. The method of claim 1, wherein setting a storage policy further comprises setting a backing store policy for the virtual machine.

10. The method of claim 9, wherein setting the backing store policy further comprises selecting at least one of a whole disk, a logical volume, a partition, and a file for the backing store.

11. The method of claim 1, wherein setting a storage policy further comprises setting a guest disk exposure policy.

12. The method of claim 11, wherein setting the guest disk exposure policy further comprises selecting whether a storage area is accessible by at least one of a single guest and multiple guests.

13. The method as in claim 1, further comprising querying the user for input when the automated configuration module determines that a selected networking policy or a selected storage policy is in conflict with the system configuration of the server.

14. A system for allocating resources of a server 104 to a virtual machine 106, comprising:
a probing module 102 configured to determine a system configuration of the server 104;
a policy module 140 configured to interact with a user to enable the user to select at least one of a networking policy and a storage policy for the virtual machine 106 to operate on the server; and
a configuration module 150 operable to configure the virtual machine 106 to operate on the server 104 based on the at least one policy selected and the system configuration determined by the probing module 102.

15. A method of allocating resources of a server 104 to a virtual machine 106, comprising:
discovering a system configuration of the server 104 using an automated probing module 102;
selecting a networking policy 140 to configure the virtual machine 106 to use one of a performance networking interface and a standard networking interface;
selecting a storage policy 140 for the virtual machine to enable the virtual machine to use one of a performance host bus adapter and a standard host bus adapter; and
configuring the virtual machine 106 to operate on the server 104 using an automated configuration module 150 based on the selected networking policy and the selected storage policy and the system configuration.
